(19) United States
(12) Patent Application Publication
(10) Pub. No.: US 2026/0002646 A1
(43) Pub. Date: Jan. 1, 2026

(54) MODULARIZED LED LIGHTING SYSTEM FOR SCALABILITY IN HORTICULTURAL APPLICATIONS

(71) Applicants: Austin Rouse, Wellington, FL (US); Anne-Marie Rouse, Wellington, FL (US)

(72) Inventors: Austin Rouse, Wellington, FL (US); Anne-Marie Rouse, Wellington, FL (US)

(21) Appl. No.: 19/250,840

(22) Filed: Jun. 26, 2025

Related U.S. Application Data
(60) Provisional application No. 63/664,995, filed on Jun. 27, 2024.

(51) Int. Cl. F21S 2/00; A01G 9/24; F21S 4/20; F21V 23/02; F21V 33/00; F21Y 105/16; F21Y 113/00; F21Y 113/10; F21Y 115/10

(52) U.S. Cl. CPC F21S 2/005; A01G 9/249; F21S 4/20; F21V 23/02; F21V 33/0052; F21Y 2105/16; F21Y 2113/10; F21Y 2113/30; F21Y 2115/10

(57) ABSTRACT

A modular lighting system includes several units of different configurations that can be combined to create lighting arrays in which the lighting elements are arranged in a staggered matrix. The units include a center square unit, linear units, and standard and reverse “L” units. Using these units a grow light array can be scaled to accommodate a given growing area while maintaining the staggered matrix arrangement of lighting elements within the array for optimum photonic distribution over the growing area.

### CROSS REFERENCE

This application claims priority to U.S. Provisional Application No. 63/664,995, filed Jun. 27, 2024, the entirety of which is hereby incorporated by reference.

### FIELD OF THE INVENTION

The present invention relates generally to horticultural lighting systems, and, more particularly, relates to a modularized system of standardized LED lighting units of different shapes that can be used to create lighting arrays of different sizes to optimize light distribution for consistency in an area under the array, and to provide spectral customization beyond what is currently available on the market today.

### BACKGROUND OF THE INVENTION

Horticultural lighting systems are used to provide artificial light for growing plants within indoor environments. A conventional lighting arrangement includes a single high intensity discharge (HID) high pressure sodium lamp (HPS) which is used to cover five by five squared feet of area. These lamps can be arranged to cover adjacent regions of approximately the same square area. A goal in these lighting systems is to achieve uniform light distribution, and in particular uniform photosynthetically active photon density in the grow area. A single light source produces a photonic density pattern as expected; a high peak photonic density directly under the lamp with a sharp drop off moving outward from that point. The photon density can vary dramatically with height of the light source, which affect the plants and they grow upward toward the lamp. Some have attempted to solve this secondary problem with moveable lamps that can be raised as the plants grow, which increases the complexity of the lighting system.

To address the photonic density variation issue, the conventional approach has been to add light elements to fill the area over the grow area with light elements. This approach has been enabled by light emitting diode (LED) technology, which allows small light emitting elements to be arranged in a matrix in a panel format over the growing area. However, while filling the overhead area with light emitting elements has produced some improvement in light uniformity in the grow area under the light panel, testing shows that these arrangements still result in a non-uniform photon distribution, with the center of the footprint (squared area) receiving the highest photonic density, which decreases in density with increasing distance from the center, under the light source.

As a result, with both single point light source fixtures, and panel fixtures, plants along the perimeter of the footprint receive less light, and growth is not uniform. Furthermore, the heat generated by these lamps can damage plants, and adjusting the height to a level that ensures damage will not occur exacerbates the non-uniformity of the light. Also, with single bulb systems where there is only one bulb with HID/HPS, spectral customization is limited to the kelvin temperature and color rendering index of that single bulb. Many have attempted to remedy this problem by using lower intensity LEDs, spread across smaller fixtures, in a matrix. All of which still result in a substantial lack of uniformity of photonic density across the growing area under the light fixture.

In U.S. Pat. No. 10,687,478 the problem of conventional LED lighting matrices using a regular matrix was discussed, and it was shown how regular matrices of rows/columns in square/rectangular patterns, with light elements at every row/column intersection, produces a deficient light distribution. It was further shown how using a staggered row/column arrangement, as is produced when a regular matrix is rotated by forty-five degrees within the same square/rectangular area, provides improved light distribution. This staggered matrix arrangement has been very successful in the market and in applications for indoor growing operations. However, the fixed staggered matrix arrays of various orders do not allow for simple scaling. Converting a second order matrix to a third order matrix would require a person to individually add light elements around the outside of the second order matrix.

Therefore, a need exists to overcome the problems with the prior art as discussed above.

### SUMMARY OF THE INVENTION

In accordance with some embodiments of the inventive disclosure, there is provided a modular lighting system for creating lighting arrays of lighting elements in a staggered matrix configuration. The system includes a center unit having a rectangular or square configuration having four corners that define at least two regular rows and at least two regular columns that are spaced one standard distant unit apart. The standard distance unit magnitude can vary from array to array, but is consistent within each lighting array. The two regular rows and two regular columns form a plurality of intersections. An intersection is defined as a point where a row meets one of the columns. There is a plurality of lighting elements. The lighting elements are distributed among the row/column intersections such that there is one lighting element disposed at each intersection of rows and columns. The center unit is a staggered matrix, so there is at least one lighting element interspersed midway between the two regular rows and the two regular columns. There are also a plurality of additional lighting units that allow expansion, outward from the center unit, of the staggered matrix. Each one of the additional lighting units includes at least one linear portion, and has a plurality of lighting elements distributed along the linear portion at intervals of one standard distance unit. These additional lighting units are positioned around the center unit, and any other linear units already in place around the center unit, at positions consistent with the staggered matrix pattern, observing the same spacing for rows and columns and positions of the lighting elements relative to those in the center unit and any other linear units around the center unit. The shape of the linear units chosen when expanding the staggered matrix depends on the particular order of the new staggered matrix being created.

In accordance with a further feature, the plurality of additional lighting units comprises at least one linear unit having a single linear portion along which there are at least two lighting elements.

In accordance with a further feature, the at least one linear unit comprises at least one linear unit having a single linear portion along which there are three lighting elements.

In accordance with a further feature, there is further included at least one L-shaped unit having a long linear portion and a short linear portion, wherein there are at least three lighting elements along the long linear portion and at least two lighting elements along the short linear portion and wherein a lighting element at a corner of the L-shaped unit is common to both the long linear portion and the short linear portion.

In accordance with a further feature, there is further included at least one reverse L-shaped unit having a long linear portion and a short linear portion, wherein there are at least three lighting elements along the long linear portion and at least two lighting elements along the short linear portion and wherein a lighting element at a corner of the L-shaped unit is common to both the long linear portion and the short linear portion.

In accordance with a further feature, the center unit and each of the plurality of additional lighting units each have a power supply mounted thereon.

In accordance with some embodiments of the inventive disclosure, there is provided a modular lighting system for creating a scalable staggered matrix of lighting elements over a growing area. The modular lighting system includes a center unit having a rectangular or square configuration that has four corners defined by at least two regular rows and at least two regular columns. The regular rows are spaced one standard distant unit apart from each other in succession, and the regular columns are spaced one standard distant unit apart, as well. The rows and columns form a plurality of intersections. The center unit further has a plurality of lighting elements, with each lighting element being disposed at a respective intersection of the plurality of intersections, meaning a 1 to 1 correspondence of lighting elements to intersections. There is also at least one lighting element interspersed midway between the two regular rows and the two regular columns. The system also includes at least one linear unit having a single linear portion along which there are at least two lighting elements that are spaced apart by one standard distance unit along the linear portion, at opposite ends of the linear portion. If there are additional lighting elements on the linear portion of the linear unit, then they are positioned at intervals along the length of the linear portion of one standard distance unit. The system also includes at least one at least one L-shaped unit, which has a long linear portion and a short linear portion. There are at least three lighting elements along the long linear portion that are spaced apart at intervals of one standard distance unit, and at least two lighting elements along the short linear portion that are spaced apart at intervals of one standard distance unit, and wherein a lighting element at a corner of the L-shaped unit is common to both the long linear portion and the short linear portion. The at least one linear unit, at least one L-shaped unit, and at least one reverse L-shaped unit are configured to be positioned around a staggered matrix, comprising at least the center unit, at positions that extend the staggered matrix outward from the center unit.

In accordance with a further feature, each of the center unit, at least one linear unit, at least one L-shaped unit each include a power supply.

In accordance with a further feature, each of the lighting elements on the center unit, at least one linear unit, and at least one L-shaped unit is a chip on board (COB) light emitting diode lighting element.

In accordance with a further feature, the at least one L-shaped unit is a reverse L-shaped unit.

In accordance with a further feature, the at least one L-shaped unit includes at least one reverse L-shaped unit.

In accordance with a further feature, there is further included at least one reverse L-shaped unit having a long linear portion and a short linear portion, wherein there are at least three lighting elements along the long linear portion that are spaced apart at intervals of one standard distance unit, and at least two lighting elements along the short linear portion that are spaced apart at intervals of one standard distance unit, and wherein a lighting element at a corner of the L-shaped unit is common to both the long linear portion and the short linear portion.

In accordance with some embodiments of the inventive disclosure, there is provided a method of arranging lighting element of a modular lighting system wherein the elements are positioned in a staggered matrix. The method includes providing a center unit that has a rectangular or square configuration with four corners that define at least two regular rows and at least two regular columns. The regular rows are spaced one standard distant unit apart and the regular columns are spaced one standard distant unit apart. Of course, the rows and columns are along lines that are perpendicular. That is, all rows are parallel and all columns are parallel, and the rows are perpendicular to the columns. The regular rows and regular columns form a plurality of intersections where a row and column meet. The center unit further has a plurality of lighting elements, where each lighting element is disposed at a respective intersection of the plurality of intersections, and there is at least one lighting element interspersed midway between the two regular rows and the two regular columns. The method further includes providing at least one linear unit that has a single linear portion along which there are at least two lighting elements that are spaced apart by one standard distance unit along the linear portion. The method further includes providing at least one at least one L-shaped unit which has a long linear portion and a short linear portion that is perpendicular to the long linear portion and extends from one end of the long linear portion. There are at least three lighting elements along the long linear portion that are spaced apart at intervals of one standard distance unit, and at least two lighting elements along the short linear portion that are spaced apart at intervals of one standard distance unit, and one of the lighting elements is at a corner of the L-shaped unit and is common to both the long linear portion and the short linear portion. The method further includes arranging a central staggered matrix including at least the center unit. The central staggered matrix can include additional linear unit or L-shaped unit around the center unit. The method also includes positioning at least two of the at least one linear unit or the at least one L-shaped unit around the central staggered matrix at positions that extend the staggered matrix pattern outward from the center unit.

In accordance with a further feature, providing at least one at least one L-shaped unit comprises providing at least one reverse L-shaped unit.

In accordance with a further feature, at least one at least one L-shaped unit comprises providing at least one regular L-shaped unit and at least one reverse L-shaped unit.

Although the invention is illustrated and described herein as embodied in a modularized LED lighting system for even photonic distribution, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

In the description of the embodiments of the present invention, unless otherwise specified, azimuth or positional relationships indicated by terms such as “up”, “down”, “left”, “right”, “inside”, “outside”, “front”, “back”, “head”, “tail” and so on, are azimuth or positional relationships based on the drawings, which are only to facilitate description of the embodiments of the present invention and simplify the description, but not to indicate or imply that the devices or components must have a specific azimuth, or be constructed or operated in the specific azimuth, which thus cannot be understood as a limitation to the embodiments of the present invention. Furthermore, terms such as “first”, “second”, “third” and so on are only used for descriptive purposes, and cannot be construed as indicating or implying relative importance.

In the description of the embodiments of the present invention, it should be noted that, unless otherwise clearly defined and limited, terms such as “installed”, “coupled”, “connected” should be broadly interpreted, for example, it may be fixedly connected, or may be detachably connected, or integrally connected; it may be mechanically connected, or may be electrically connected; it may be directly connected, or may be indirectly connected via an intermediate medium. As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the article being references. The terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system. Those skilled in the art can understand the specific meanings of the above-mentioned terms in the embodiments of the present invention according to the specific circumstances.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a plan view of a center unit for a modular LED lighting system for horticultural applications, in accordance with the inventive disclosure.

FIG. 2A is a plan view of a linear unit in a first orientation for a modular LED lighting system for horticultural applications, in accordance with the inventive disclosure.

FIG. 2B is a plan view of the linear unit of FIG. 2A, in a second orientation, for a modular LED lighting system for horticultural applications, in accordance with the inventive disclosure.

FIGS. 3A, 3B, 3C, and 3D are plan views of the same reverse “L” shaped unit, in various rotational orientations, for a modular LED lighting system for horticultural applications, in accordance with the inventive disclosure.

FIGS. 4A, 4B, 4C, and 4D are plan views of the same “L” shaped unit, in various rotational orientations, for a modular LED lighting system for horticultural applications, in accordance with the inventive disclosure.

FIG. 5A shows a modular build of a 3×3 array using modular units of the modular LED lighting system, in accordance with the inventive disclosure.

FIG. 5B shows the lighting element pattern of the 3×3 array of FIG. 5A.

FIG. 5C shows the lighting element pattern is a rotated square matrix.

FIG. 6 shows a modular build of a 4×4 array using modular units of the modular LED lighting system, in accordance with the inventive disclosure.

FIG. 7 shows a modular build of a 5×5 array using modular units of the modular LED lighting system, in accordance with the inventive disclosure.

FIG. 8 shows a modular build of a 6×6 array using modular units of the modular LED lighting system, in accordance with the inventive disclosure.

FIG. 9 shows a plan view of a center unit for a modular LED lighting system for horticultural applications in which the center LED unit is replaced with a camera for monitoring plant growth in order to control the lighting to optimize plant growth, in accordance with some embodiments.

FIG. 10 shows a plan view of a modular LED lighting system for horticultural applications including multiple cameras for monitoring plant growth in order to control the lighting to optimize plant growth, in accordance with some embodiments.

FIG. 11 shows a plan view of an augmented LED unit for use in a modular LED lighting system for horticultural applications in which there are additional LED strips that provide supplemental spectral output, in accordance with some embodiments.

FIG. 12 shows a plan view of a modular LED lighting system including both cameras and additional LED strips, in accordance with some embodiments.

FIG. 13 is a block schematic diagram of a modular LED lighting system control flow, in accordance with some embodiments.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides a novel and efficient scalable modular LED lighting system for horticultural applications. As identified in U.S. Pat. No. 10,687,478, the disclosure of which is hereby incorporated by reference, a staggered matrix, which results from rotating a square matrix by forty five degrees within a reference square or rectangle, provides better photon distribution over the area of the reference square than a square matrix. This staggered matrix includes regular columns and rows with additional columns and rows offset by half a distance interval and requires there being an odd number of rows and an odd number of columns, in general. This results in a “matrix within a matrix.” Thus, for example, a 3×3 staggered matrix includes a 3×3 regular matrix with a 2×2 matrix disposed within the 3×3 matrix between the rows and columns of the 3×3 matrix. The inventive modular lighting system includes a set of lighting elements of different shapes and sizes that can be used to build various scaled staggered matrix lighting assemblies quickly and easily, rather than building fixed arrays of different sizes.

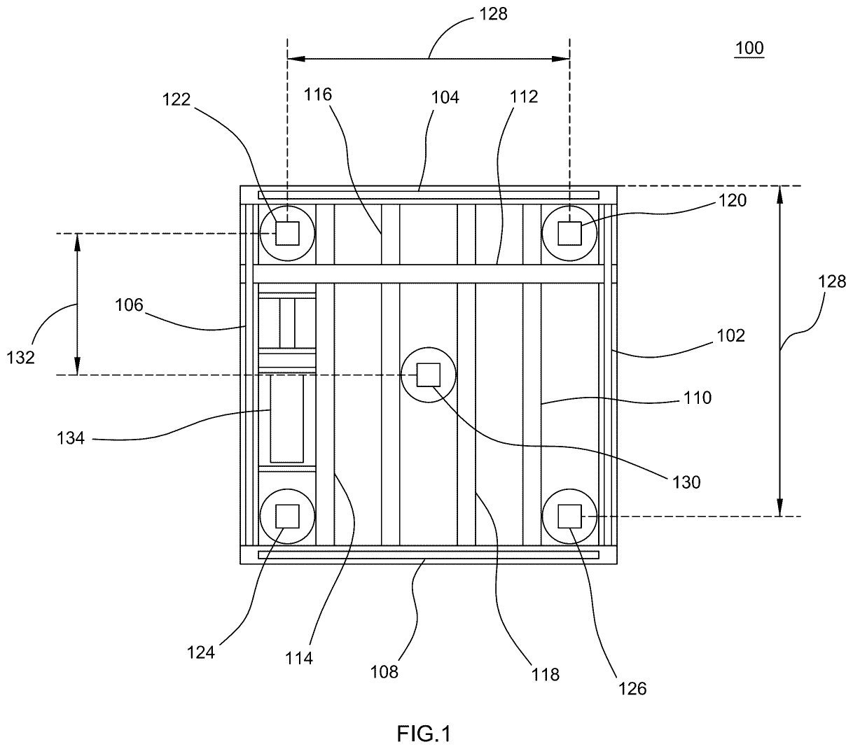

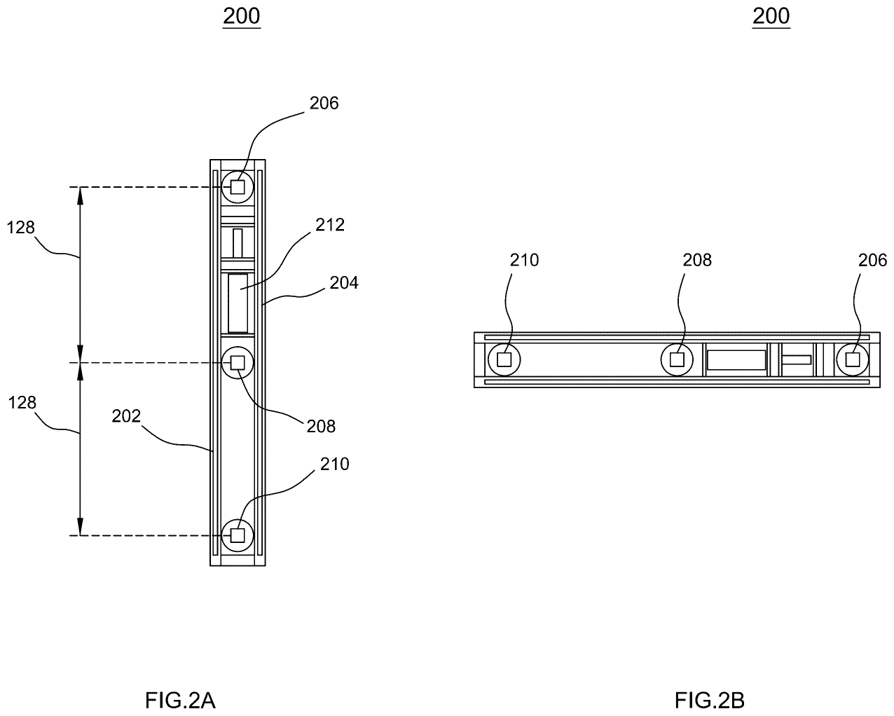

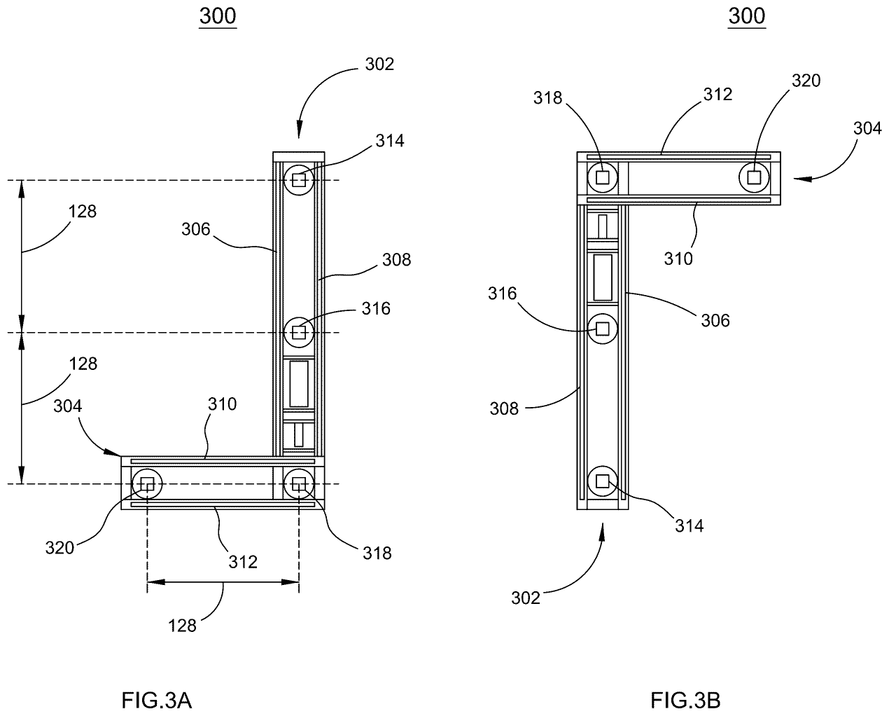

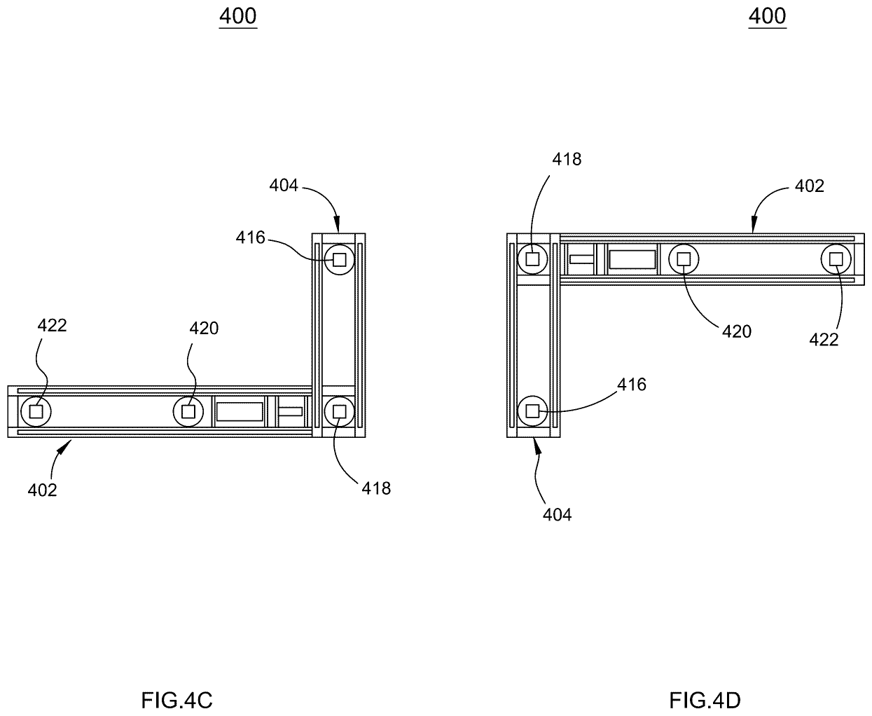

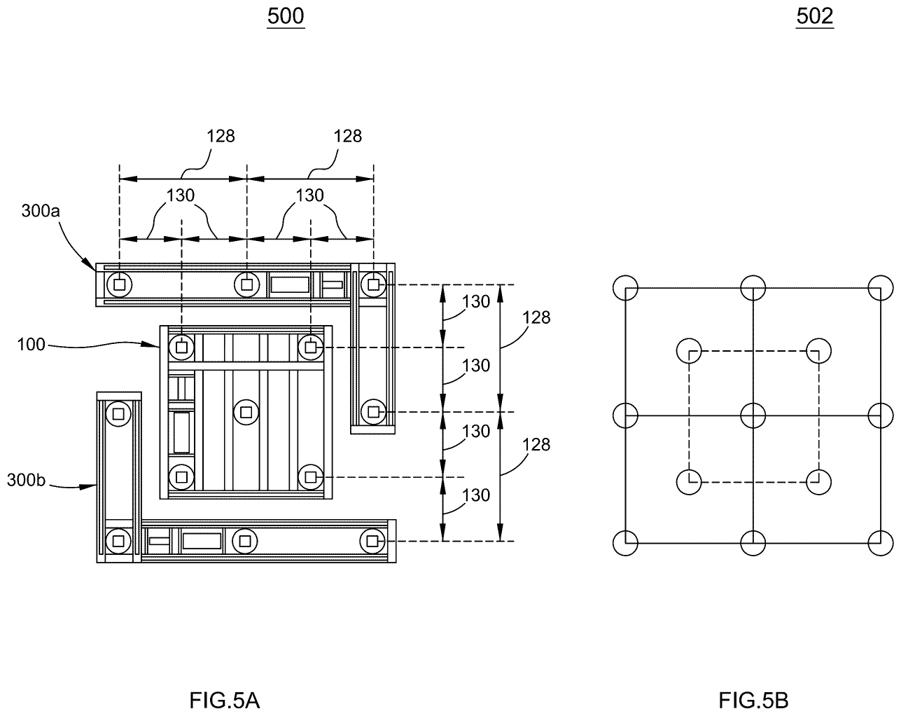

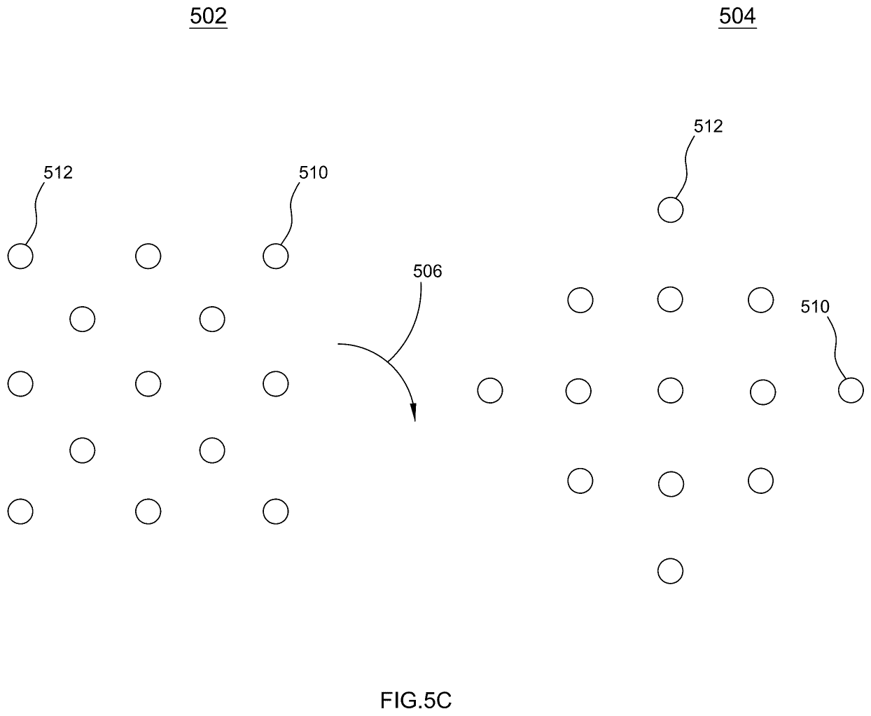

FIG. 1 is a plan view of a center unit 100 for a modular LED lighting system for horticultural applications, in accordance with the inventive disclosure. The view here, and in FIGS. 2A-2B, 3A-3D, 4A-4D, 5A-5C, and FIGS. 6-8, are all from a perspective of being below the unit being discussed, if the unit were suspended or otherwise mounted for normal use. In such a position, all of the LED elements will be in the same horizontal plane over the ground, or whatever horticultural space is below the unit or lighting assembly. Further, the views are all aligned to one of a zero-degree, ninety degree, one hundred eighty degree, or two hundred seventy-degree orientation relative to the unit or assembly being viewed, except for FIG. 5C where a staggered matrix is rotated forty five degrees in its plane to show how a staggered matrix is related to a regular matrix. As such, any reference to “top,” “bottom”, “side” with respect to the drawings is relative to the page being viewed on which the drawing is shown.

The center unit 100 is the smallest staggered matrix size, having a 2×2 matrix LED elements with a single, LED element centrally located in the 2×2 matrix. The center unit 100 includes a square frame made of outside frame members 102, 104, 106, and 108 which form the outside of the frame of the center unit 100. There are additional frame members 110, 112, 114, 116, and 118 as well, which traverse the interior of the frame boundary created by frame members 110-116. The frame members in general are rigid struts that can be attached to or fastened to each other to create a frame for holding the LED elements and power supply. At each corner of the square frame there is a LED element 120, 122, 124, 126. The LED elements can be “chip in board” (COB) LED elements and are selected to produce a horticulturally significant light spectrum output. The centers of the four corner LED elements 120, 122, 124, 126 are located a standard distance unit 128 apart along each side of the frame (e.g. not in the diagonal direction). Thus, the distance between LED element 120 and LED element 122 is the same as the distance between LED element 120 and LED element 126. This distance is termed a standard distance unit herein. In some embodiments the standard distance unit can be on the order of ten to twelve inches. Being a staggered matrix, there is also a center LED element 130 that is positioned in a row/column that is a distance 130 from rows/columns of the 2×2 matrix that is half a standard distance unit 128. A power supply 134 can be attached to the frame members and distribute power to each of the LED elements 120, 122, 124, 126, 130. The frame members and the LED elements are generally co-planar, and when deployed for use are co-planar in a horizontal plane relative to the ground or floor (e.g., the plane is perpendicular to the direction of gravity).

The center unit 100 is considered the central “building block” for arranging larger staggered matrices to cover larger growing areas. The subsequently described units are designed to be placed around the center unit 100 to build larger staggered matrices. Thus, the center unit 100 is present in every staggered matrix array. Each staggered matrix includes a major matrix where the lighting elements are positioned at the intersections of regular rows and columns that are spaced a standard distance unit apart. In addition, to make it a staggered matrix, there is a minor matrix of one order smaller than the major matrix that has rows and columns interspersed between the rows and columns of the major matrix. Thus, the center unit has at least two regular rows and two regular columns. In center unit 100, one row is defined by lighting elements 122 and 120, and a second row is defined by lighting elements 124 and 126. One columns is defined by lighting elements 122 and 124, and a second column is defined by lighting elements 120 and 126.

FIG. 2A is a plan view of a linear unit 200 for a modular LED lighting system for horticultural applications, having a first orientation, and FIG. 2B is a plan view of the linear unit 200 in a second orientation, in accordance with the inventive disclosure. The linear unit 200 includes parallel frame members 202, 204 along the elongated direction of the linear unit 200. Mounted at each end of the linear unit 200 are LED elements 204, 210, and there is a centrally located LED element 208 that is located one standard distance unit 128 from each of the LED elements 206, 210 at the opposite ends of the linear unit 200. Thus, the linear unit includes at least three LED elements arranged in a line, and the LED elements are spaced one standard distance unit 128 from each other for the particular modular LED lighting system. A power supply 212 is also mounted on the frame members 202, 204, and provides power to the LED elements 206, 208, 210. One or more linear units 200 can be arranged around the central unit 100, alone, or in combination with either or both of the “L” shaped units described below to create large staggered matrices. In this example, the major matrix has an order of two (2×2) and the minor matrix has an order of one.

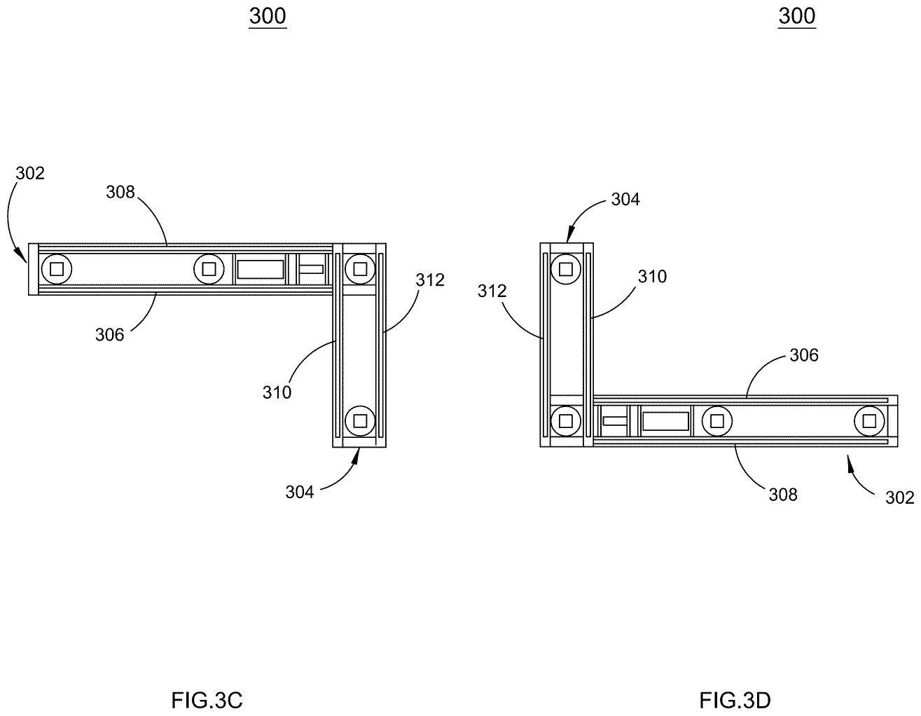

FIGS. 3A, 3B, 3C, and 3D are plan views of the same reverse “L” shaped unit, in various rotational orientations, for a modular LED lighting system for horticultural applications, in accordance with the inventive disclosure. FIG. 3A shows the reverse “L” orientation, while FIG. 3B shows the unit 300 rotated within the plane of the unit 300 by one hundred eighty degrees relative to FIG. 3A, FIG. 3C shows the unit 300 rotated ninety degrees relative to FIG. 3A, and FIG. 3D shows the unit 300 rotated negative ninety degrees relative to FIG. 3A.

The unit 300 includes a long linear portion 302 having two ends, and a shorter linear portion 304 that extends from one end of the long linear portion 302 at a perpendicular direction. In unit 300 the position of the short linear portion 304, extending to the left from the end of the long linear portion that is closest to the bottom of the drawing page forms a reverse “L” shape. The long linear portion 302 includes elongated frame members 306, 308 on opposite sides of the long linear portion 302. The short linear portion 304 includes frame members 310, 312 that are opposite of each other on the sides of the short linear portion 304. The long linear portion includes LED elements 314, 316, 318 along the length, with LED elements 314 and 316 at opposite ends, and LED element 316 located centrally between them at one standard distance unit 128. The short linear portion 304 adds LED element 320 at the distal end of the short linear portion and is spaced from LED element 318, positioned in the corner wherein the long and short linear portions 302, 304 meet, by one standard distance unit 128. A larger configuration of the reverse-L unit 300 can include, for example, four LED elements along a long linear portion, and three LED elements along the short linear portion, with one LED in the corner being common to both the long and short linear portions.

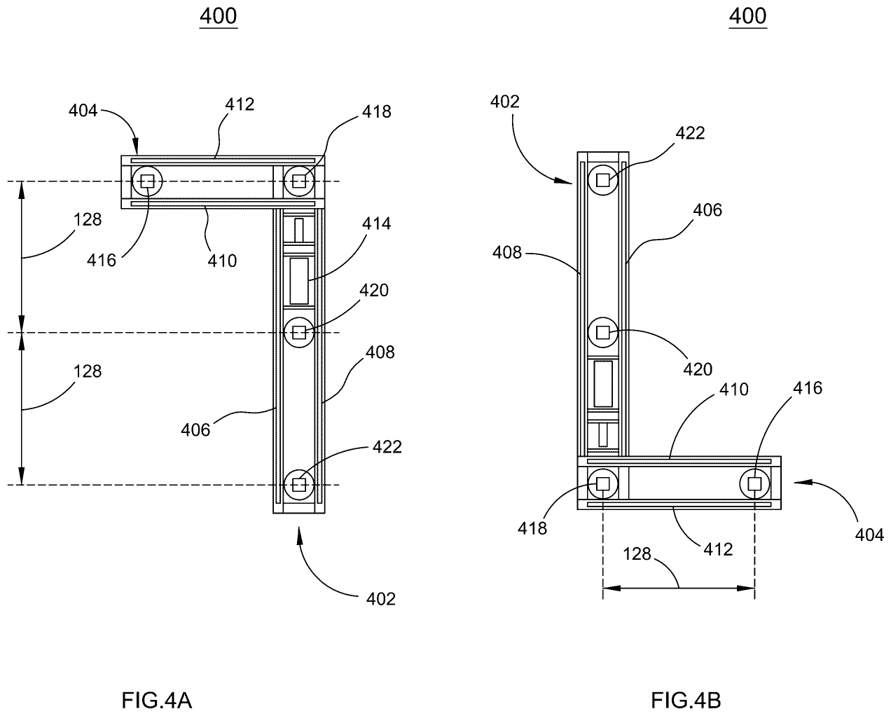

FIGS. 4A, 4B, 4C, and 4D are plan views of the same “L” shaped unit 400, in various rotational orientations, for a modular LED lighting system for horticultural applications, in accordance with the inventive disclosure. Unit 400 is identical to unit 300 with the exception that the short linear portion 404 extends to the right, as seen in FIG. 4B, from the corner where it meets the long linear portion 402, forming an “L” shape. FIG. 4A shows the unit 400 rotated one hundred eighty degrees relative to FIG. 4B, and FIGS. 4C and 4D show the unit 400 rotated ninety degrees and negative ninety degrees, respectively, relative to FIG. 4B.

As shown in FIG. 4A, the long linear portion 402 comprises opposing parallel frame members 406, 408 in the elongated direction of the long linear portion 402. The short linear portion 404 comprises frame members 410, 412, which are parallel to each other and which intersect with frame members 406, 408 at the corner of the unit 400, where LED element 418 is located, and common to both the long and short linear portions 402, 404. LED elements 418, 420, and 422 are disposed along the length of the long linear portion 402, separated by one standard distance unit 128, with element 418 in the corner at one end of the long linear portion 402, element 420 centrally located between elements 418 and 422, and element 422 being at the opposite end of the long linear portion 402 from element 418. The short linear portion 404 adds LED element 416 at one standard distance unit 128 from LED element 418 (as indicated in FIG. 4B). Power supply 414 can be located on the long linear portion 402 as well.

Using only the center unit 100, linear unit 200, and reverse-L and L-shaped units 300, 400 a wide variety of lighting assemblies can be built, and scaled to the optimum sized over the growing time of a given plant type. The smallest assembly would be made using just a central unit 100, providing a 2×2 staggered array. Then, surrounding the center unit 100 with other units allows the creation of larger assemblies while keeping the staggered matrix configuration. Several examples follow, and FIGS. 5A-5C illustrate how the staggered matrix configuration is maintained while scaling up the lighting assembly.

As a first example, FIG. 5A shows a modular build of a lighting assembly 500 in the configuration of a 3×3 array using modular units of the modular LED lighting system, in accordance with the inventive disclosure. In particular there is a center unit 100 that is surrounded by two reverse-L units 300a, 300b. Each of the reverse-L units 300a, 300b are identical to the reverse-L unit 300 of FIGS. 3A-3D, including having a long linear portion with three LED elements positioned at standard distance unit 128 apart, and a short linear portion oriented at a ninety-degree angle to the long linear portion, and extending from a corner at intersecting ends of the short and long linear portions. The short linear portion has two LED elements, including one at the corner of the unit 300 that is common to the long linear portion. The LED elements in any column or row are positioned one standard distance unit 128 apart. However, from row to row, or column to column, because the rows/columns are staggered, the rows and columns, meaning the center line of each row/column are one half of a standard distance unit 130 apart. Thus, within the 3×3 matrix created by the reverse-L units 300a, 300b, and the LED element at the center of the center unit 100, there are three rows and three columns of three LED elements in each row & column. The LED elements at corners of the center unit 100 form a 2×2 matrix with the 3×3 matrix, on staggered rows & columns between the rows and columns of the 3×3 matrix. Thus, in a 3×3 staggered matrix there is a major matrix that is a regular 3×3 matrix of nine LED elements, and the minor matrix that is interspersed with the major matrix is a regular 2×2 matrix.

This arrangement 502 of LED element is shown in FIG. 5B. Solid lines show the rows and columns of the major matrix, which is a regular 3×3 matrix. The dashed lines show the rows and columns of the minor matrix, which is a regular 2×2 matrix interspersed within the major matrix. In both the major 3×3 matrix and the minor 2×2 matrix, the centers of the lighting elements positioned at each intersection of a row and a column are one standard distance unit apart.

The center 3×3 matrix and each of the reverse-L units 300a, 300b are fabricated as individual units, including their own frame or sub-frame, and do not share a common frame for supporting the LED elements of the respective modules. However, the modules 100, 300a, 300b can be mounted on a common support structure, or then can be positioned as shown on separate support structures for each module 100, 300a, 300b. The modularity allows builds of lighting arrays having various scales and shapes while continuing the staggered matrix pattern.

In FIG. 5C the arrangement 502 is shown, where LED element positions 510, 512 at the top corners are identified. In arrangement 504, arrangement 502 has been rotated by forty-five degrees as indicated by arrow 506, and the positions 510, 512 have been moved accordingly. In arrangement 504, it can be seen that the positions of the LED elements, represented by circles (e.g. 510, 512) form a pattern corresponding to a regular matrix, but with spacings that are less than the standard distance unit as a result of being the short sides of an isosceles triangle. However, a regular matrix of LED elements over a corresponding growing area has been found to produce less consistency of photon distribution over the growing area under the matrix compared to that achieved by a staggered matrix as in arrangement 502.

Those skilled in the art will realize that the same 3×3 staggered arrangement could be produced by surrounding a center unit 100 with four 2×1 linear units. For example, each of the reverse-L units 300a, 300b could be broken into two 2×1 linear units. Although the effect would be the same, in terms of producing a 3×3 staggered matrix, each 2×1 unit would require its own power supply and power feed, effectively doubling the wiring work needed to implement the same 3×3 staggered matrix as using two L shaped units. It will further be appreciated that the same effect can be achieved using two (regular) L-shaped units 400. Beyond the center unit 100, the additional units are all linear (e.g., unit 200) or L-shaped, being made of two linear portions joined at a corner (e.g., units 300, 400). By “linear” it is meant that all of the lighting elements are arranged along a single straight light, which can become part of a row or column being added around the center unit or added around a smaller staggered matrix.

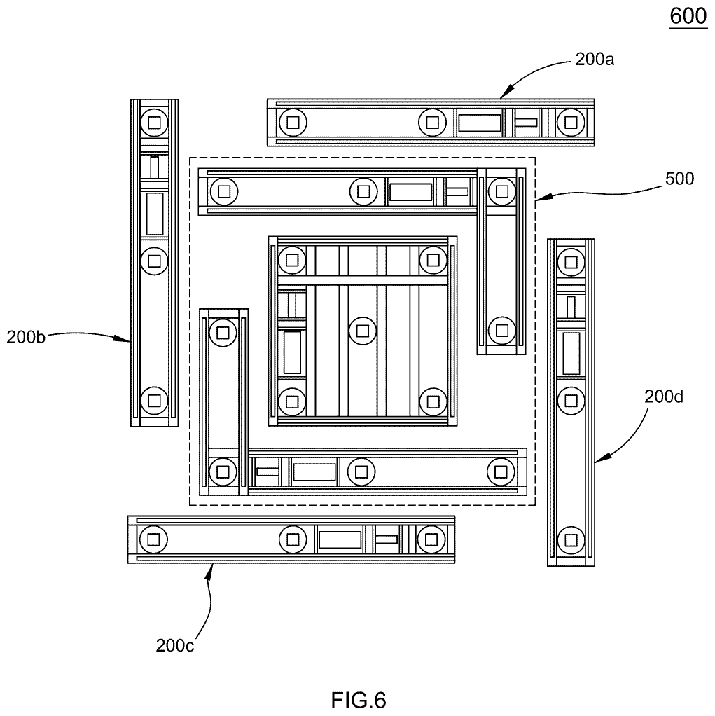

FIG. 6 shows a modular build of a 4×4 array 600 using modular units of the modular LED lighting system, in accordance with the inventive disclosure. In particular, the array 600 starts with the lighting assembly 500 as shown in FIG. 5A, and adds linear units 200a, 200b, 200c, and 200d around the outside. Because the linear units 200a-200d represent another order of a staggered matrix, the LED elements on units 200a-200d are aligned in rows and columns with the LED elements of the center unit in assembly 500, and are offset from those of reverse-L units of assembly 500. Thus, the 4×4 matrix staggered matrix includes a regular 4×4 matrix with a regular 3×3 matrix inside and offset from the rows and columns of the 4×4 matrix by one half of a standard distance unit. In this example the 4×4 staggered matrix includes a major matrix that is a regular 4×4 matrix with a minor matrix consisting of a regular 3×3 matrix interspersed within the major matrix. When the order of an array is increased by one (1), such as going from a 4×4 to a 5×5 array, what was the minor matrix in the 4×4 array becomes part of the major matrix of the 5×5 array, along with the new lighting units that are added around the outside of the 4×4 array. And likewise, what was the major matrix in the 4×4 array becomes the minor matrix in the 5×5 array.

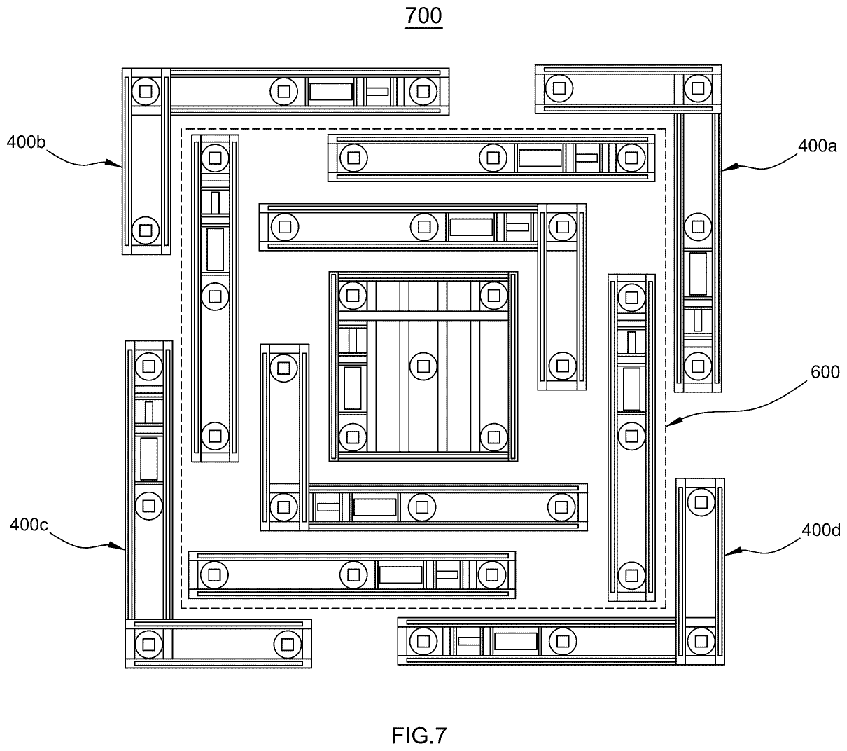

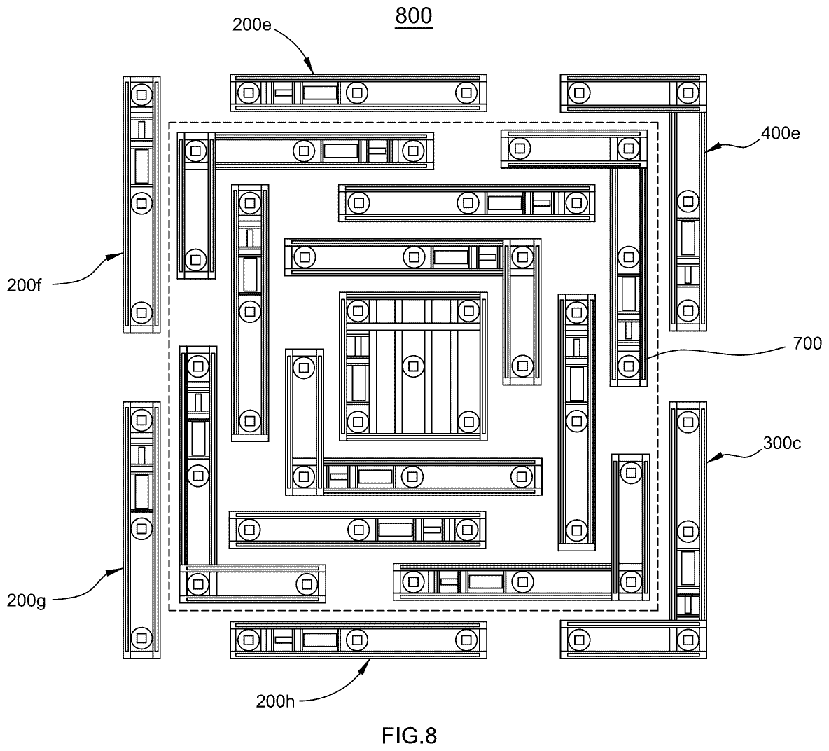

FIG. 7 shows a modular build of a 5×5 array 700 using modular units of the modular LED lighting system, in accordance with the inventive disclosure. The array 700 adds another order of LED elements around the 4×4 array 600 by adding L shaped units 400a-400d around the outside of the 4×4 matrix. The LED elements of the L-shaped units 400a-400d are offset, in vertical columns and horizontal rows, from the LED elements of the linear units 200a-200d around the outside of array 600, continuing the staggered matrix. Likewise, FIG. 8 shows a modular build of a 6×6 array 800 using modular units. Unlike previously described arrays of smaller order, the outside of the 6×6 array mixes units and thus includes linear units 200e, 200f, 200g, and 200h along with reverse-L shaped unit 300c and L-shaped unit 400e. As with prior orders, the LED elements of units 200e-200h, 300c, and 400e are offset compared to those of the outside of the lower order array (e.g. 700). Thus, array 800 includes array 700, which includes array 600, which include assembly 500, which includes center unit 100. In reverse order, these represent staggered arrays of orders 2×2, 3×3, 4×4, 5×5, and 6×6. Still higher order staggered arrays can be built using the modular units 100, 200, 300, and 400.

FIG. 8 shows a modular build of a 6×6 array 800 using modular units of the modular LED lighting system, in accordance with some embodiments. As with prior examples, the 6×6 array 800 can start with the 5×5 array 700, and add linear units 200e, 200f, 200g, and 200h, in conjunction with reverse-L unit 300c and standard-L unit 400e. A 6×6 array is five standard distance units 128 along each side, and covers a corresponding-sized growing area. It will be appreciated that larger square arrays, and rectangular arrays of desired sizes can be constructed using the same basic four elements of one or more center units, linear units, and reverse-L and standard-L shaped units. Although the units 200, 300, and 400 shown here have a maximum length of two standard distance units, it is understood that these can be scaled up or down for larger or smaller arrays. For example, linear units having four LED elements that are three standard distance units in length (from one end LED element to the opposite end LED element). Likewise, L-shaped units with four LED elements in one direction and two or three LED elements in the short linear portion can be used for larger arrays, either square or rectangular arrays. The four basic units are a 2×2 center unit, linear units, and L-shaped units of both reverse and standard orientations. With these elements, various order arrays of staggered matrices can be constructed for different sized growing areas, accordingly.

Thus, a method for arranging lighting elements of a modular lighting system, wherein the lighting elements are positioned in a staggered matrix, is also inherently disclosed. The method includes providing at least a center unit (e.g., 100), at least one linear unit (e.g., 200) and at least one L-shaped unit (e.g., 300 and/or 400). In scaling a lighting array, several of the linear lighting units are added around the central unit. The lighting elements of the central unit are arranged in a staggered matrix of at least a 2×2 staggered configuration, with four lighting elements at the four corners of the unit, all spaced apart by one standard distance unit, and a centrally positioned lighting element that is positioned exactly halfway between the rows and columns of the 2×2 major matrix. To scale the array, additional linear units are added around the center unit, and any other linear units that are already present around the center unit. The linear units all use the same standard distance unit spacing between lighting elements. Accordingly, the linear units are added around the center unit at positions that continue the staggered matrix pattern outward, as exemplified in FIGS. 5A, 6, 7, and 8. This means that the linear units being added positioned such that their lighting elements are positioned in rows and columns parallel to those of the center unit, but offset one half of a standard distance unit to continue the staggered matrix pattern outward. The outermost linear units define the major matrix, and the next layer in from the outermost linear units defines the minor matrix.

A modular system for horticultural lighting systems has been disclosed that allows the construction of various orders or sizes of arrays using a basic set of units. In particular, square arrays from a 2×2 to a 6×6 arrays of square staggered matrices can be constructed with the same four elements, including a 2×2 center unit, linear units, and reverse and standard L-shaped units. Each of these units includes several LED elements arranged at specific intervals of distance-a standard distance unit—that allows the arrangement of staggered matrices where there is a major matrix with a minor matrix also using the same standard distance unit between its columns and row and that is interspersed between the rows/columns of the major matrix. More generally, the disclosed system allows the construction of various sized lighting arrays by the use of a center unit and one or more additional lighting units that are all composed of linear portions to be arranged around the center unit or other linear portions already in place around the center unit to create larger staggered matrices. Each staggered matrix includes a major matrix that defines outside rows and columns, and additional rows and columns inside. The rows and columns define lines, and the spacing between each row and each column is the standard distance unit. Lighting elements are positioned at the intersections of these rows and columns, including at the corners of the matrices as each corner is an intersection of a row and a column. A minor matrix is interspersed within the major matrix, also having rows and columns that the spaced one standard distance unit apart, and offset from the rows and columns of the major matrix by one half of a standard distance unit. Thus, where the rows and columns of the major matrix define squares, the lighting elements of the minor matrix are located in the centers of those squares defined by the rows and columns of the major matrix. The disclosed system provides the benefit of being able to scale up a growing system as needs dictate, without having to replace a smaller array with a larger array. Rather, to create a larger array for a larger growing area, the grower can simply add units around the existing array, and the design of the additional units is such that they will preserve the staggered matrix arrangement, creating a new major matrix. In addition to the center unit, which is square or rectangular (e.g., a 3×2 unit), the additional units are all comprised of linear segments. Either a straight linear unit, or an L-shaped unit with a long linear portion and a short linear portion. In terms best understood by the foregoing description and examples, a linear segment means a single line of lighting elements. Linear unit 200, for example, includes three lighting elements arranged in a line, and spaced apart by the standard distance unit. The “L” shaped units each have one long linear portion and one short linear portion that is perpendicular to the long linear portion and they meet at a common end of the two linear portions. In units 300 and 400, for example, the long linear portion and the short linear portion each have the corner lighting element in common, with two additional lighting elements in the long linear portion, and one additional lighting element in the short linear portion, and again, the lighting elements are arranged in lines and spaced one standard distance unit apart, center to center of each lighting element.

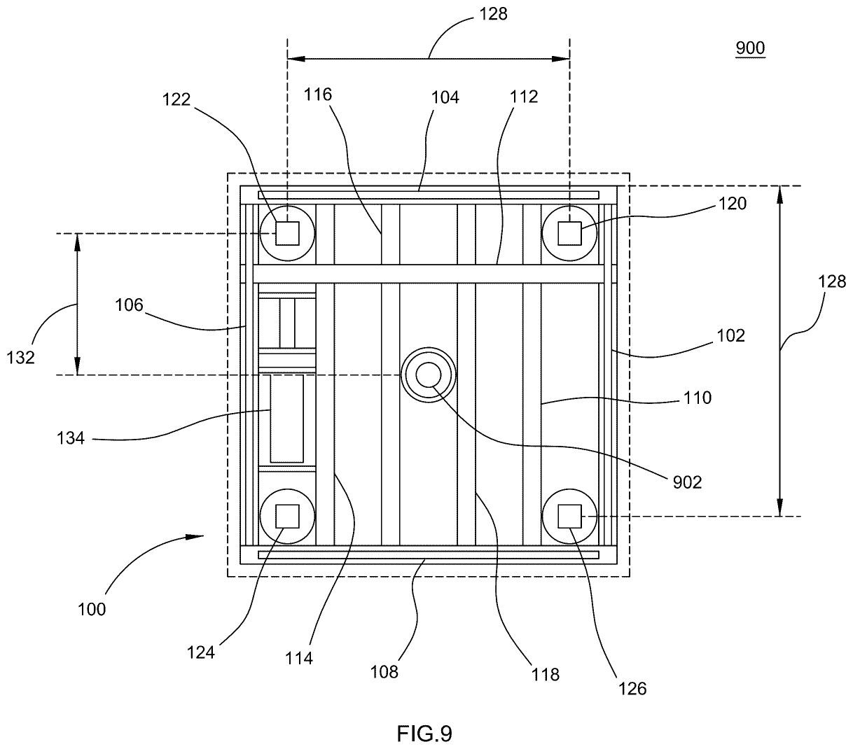

FIG. 9 shows a plan view of a center unit 100 for a modular LED lighting system 900 for horticultural applications in which the center LED unit is replaced with a camera 902 for monitoring plant growth in order to control the lighting to optimize plant growth, in accordance with some embodiments. The center unit 100 is substantially similar to that of FIG. 1, with the difference of the center LED unit 130 being replaced with a cameral 902. The elimination of the central LED unit 130, it has been found, in some applications lessens the tendency of a central “hot spot” to be produced. That is, there being an imbalance of photonic distribution with an excess being located under the central LED unit 130. At the same time, the inclusion of a camera 902 that is sensitive to the relevant spectra of light can be used to ensure that the optimum level of light is being delivered to the plant canopy, as well as at lower regions of the plant growth under the modular LED system 900. The camera 902 can also be used for image recognition purposes to identify problems in plant growth, and take action, accordingly. That is, the camera 902 can produce images that can be evaluated to judge, for example, the distance between the lighting array and the canopy, differences in height in the canopy, and other such parameters, and adjust the individual LED unit output among the LED units 120, 122, 124, 126, as well as the output of additional LED units in additional modular sections included in the complete modular LED system 900, to address any growth disparity among the plants under the LED array or other growth issues.

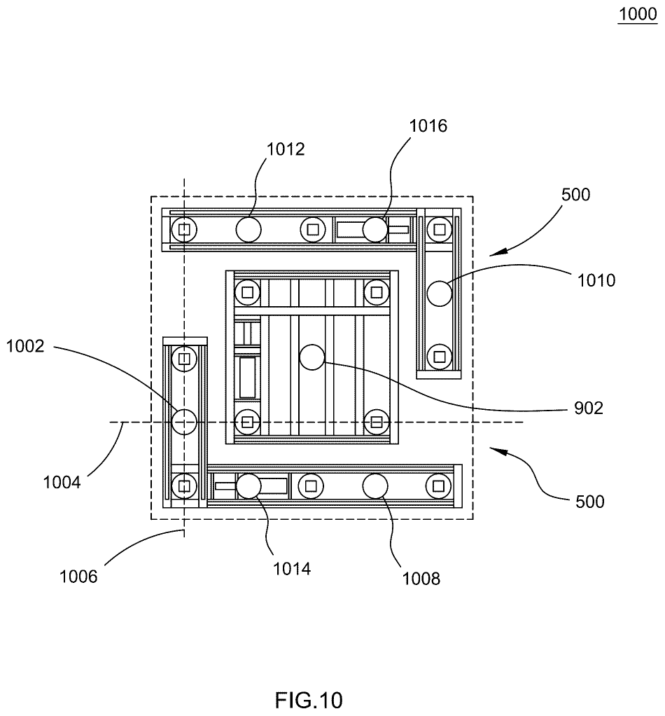

FIG. 10 shows a plan view of a modular LED lighting system 1000 for horticultural applications including multiple cameras for monitoring plant growth in order to control the lighting to optimize plant growth, in accordance with some embodiments. The system 1000 modifies a second order array of light assembly 500 by not only replacing the central light unit 130 with a camera 902, and also including multiple other cameras 1002, 1010, 1012, 1014. Each of these cameras 1002, 1010, 1012, 1014 are distributed between LED units on the frame of the modular units, as well as in the center of the central unit 100. These cameras can be aligned with the row/column lines 1004, 1006 in some embodiments, or placed more closely to the LED units in some embodiments. The additional cameras 1002, 1010, 1012, 1014 provide more information about the state of the plants, with each camera 1002, 1010, 1012, 1014 having a unique viewing angle. The images produced by the cameras 902, 1002, 1010, 1012, 1014 can be used to individually adjust the light output of each LED unit in the system 1000 based on the state of the plant growth.

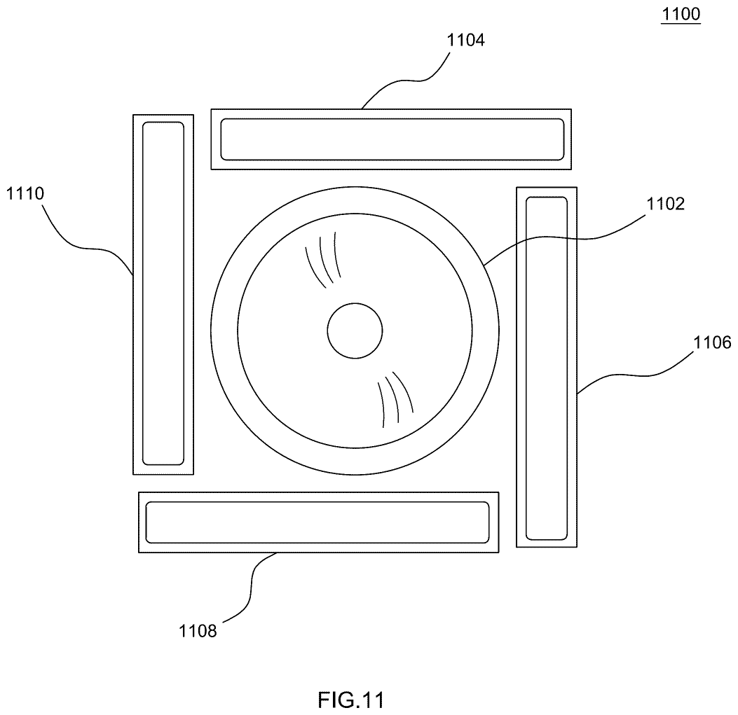

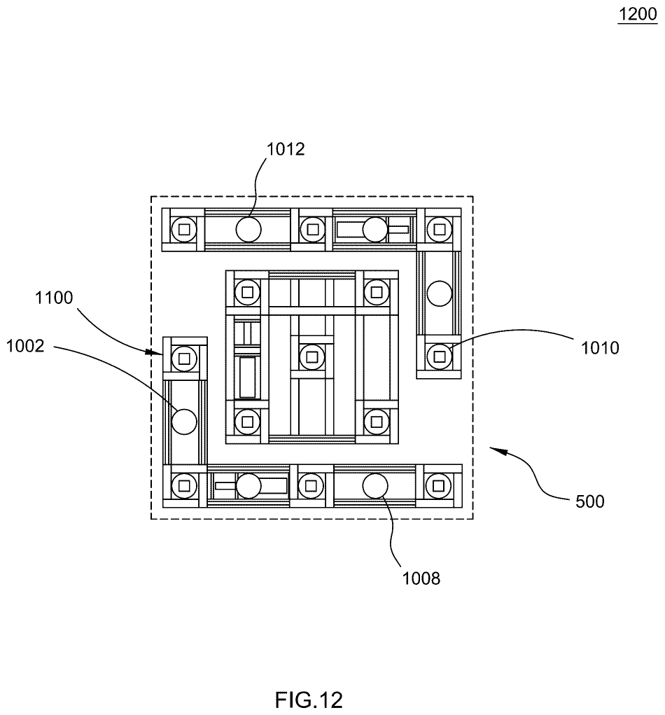

FIG. 11 shows a plan view of an augmented LED unit 1100 for use in a modular LED lighting system for horticultural applications in which there are additional LED color strip lighting elements that provide supplemental spectral output, in accordance with some embodiments. The additional LED strips comprise a halo around a central lighting element such as a chip-on-board LED element 1102, and can include, for example, two light LED color strips 1104, 1106 that provide red light at about 660 nm wavelength, an infrared light color strip 1108 that provides infrared light at about 730 nm wavelength, and one blue light color strip 1110 that provides blue light at about 450 nm wavelength. The halo of LED strips 1104, 1106, 1108, 1110 can be mounted on the aluminum frame elements. The red strips 1104, 1106, infrared strip 1108, and blue strip 1110 can be controlled by three separate drivers (the two red strips 1106, 1108 being jointly controlled) so that an optimum spectral output, including the central COB element 1102, can be delivered to the plant growth beneath the array. FIG. 12 shows a plan view of a modular LED lighting system 1200 including both cameras and additional LED strip halos, in accordance with some embodiments. The lighting system 1200 using a second order lighting assembly 500 substantially as show in FIG. 5A, but also includes cameras 1002, 1008, 1010, and 1012, and each led unit 1100 includes both a central COB element and a surrounding halo of color strips as shown in FIG. 11. Each light element and strip can be individually controlled in some embodiments. This means the light output of each COB element, and each color of the halo color strips, at each lighting element position, can be individually controlled to deliver a determined optimum spectral output and intensity to the plant growth beneath the lighting system 1200. The camera in the central unit (e.g. 902) is not shown here, but could replace the central lighting unit in whole or in part (e.g. replacing only the COB element while retaining the halo color strips).

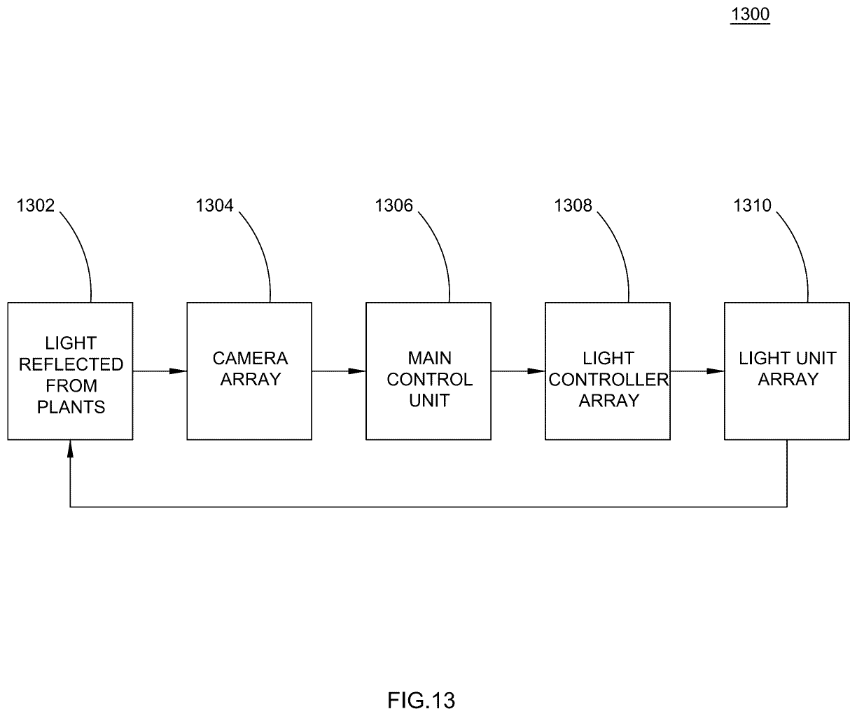

FIG. 13 is a block schematic diagram 1300 of a modular LED lighting system control flow, in accordance with some embodiments. Each lighting system includes a center unit having a rectangular or square frame in a configuration with four corners that define at least two regular rows and at least two regular columns that are spaced one standard distant unit apart. The rows and columns form a plurality of intersections where each row meets one (or more) of the columns. There are a plurality of lighting elements disposed on the frame, and each lighting element is disposed at one intersection. There is at least one lighting element interspersed midway between the rows and the columns, too. There is also a plurality of additional lighting units in the modular design, where each one of the additional lighting units includes at least one linear portion and has a plurality of lighting elements distributed along the linear portion at intervals of one standard distance unit. Each one of the lighting units of a given lighting array includes a COB element and can further include a halo of color strips include red, infrared, and blue light strips. Each of these light strips and the COB element can be individually controlled, meaning the light output can be adjusted between a minimum light output level (including being turned off) and a maximum light output level.

In the process flow of diagram 1300, a lighting array such as any of the lighting arrays disclosed herein, is provided over growing plants. Light from the array is output and incident on the plants. Some of the light, in an appropriate spectral range, is absorbed by the plants for photosynthesis, and some light is reflected by the plants in block 1302. In block 1304 the reflected light is imaged by the camera array to produce image data, which includes at least one camera mounted on the frame. The image data of the image or images produced by the camera or cameras is then evaluated in block 1306 by a main control unit. The main control unit is configured to control the light output level of every lighting element in the array. The main control unit can correlate the positions of plants under the array with specific light elements, and adjust individual light elements to address disparity in plant growth among the plants under the lighting array. Accordingly, in block 1308 the main controller sends control signals to a light controller array (drivers) that control the output of each lighting element individually, including each COB element and each color strip (if present). In response, in block 1310, each lighting element is adjusted to optimize and equalize plant growth and plant health among the plants under the lighting array. The process occurs iteratively as indicated by the return arrow from block 1310 to block 1302. The process can occur at regular intervals as selected by the operator of the lighting array. In some embodiments the interval can be once per hour, once per day or once per week, or any other interval deemed to be effective.

The disclosed system integrates a unique geometry of lighting element distribution, using a staggered matrix of lighting elements, among a modular frame system that allows the configuration of various-sized array. The modular elements allow the staggered matrix configuration to be expanded as desired, rather than having to manufacture, or buy, large arrays in specific sizes. In addition, the disclosed system can incorporate one or more cameras and color strip halos to optimize the spectral output of the lighting array based on plant growth.

The claims appended hereto are meant to cover all modifications and changes within the scope and spirit of the present invention.

What is claimed is:

1. A modular lighting system for creating lighting arrays of lighting elements in a staggered matrix configuration, comprising:
a center unit having a rectangular or square configuration having four corners that define at least two regular rows and at least two regular columns that are spaced one standard distant unit apart, wherein the at least two regular rows and at least two regular columns form a plurality of intersections where each row of the at least two regular rows meets one of the at least two regular columns, and a plurality of lighting elements where each lighting element of the plurality of lighting elements is disposed at one intersection of the plurality of intersections, and there is at least one lighting element interspersed midway between the at least two regular rows and the at least two regular columns; and
a plurality of additional lighting units, each one of the plurality of additional lighting units comprised of at least one linear portion and having a plurality of lighting elements distributed along the linear portion at intervals of one standard distance unit.

2. The modular lighting system of claim 1, wherein the plurality of additional lighting units comprises at least one linear unit having a single linear portion along which there are at least two lighting elements.

3. The modular lighting system of claim 2, wherein the at least one linear unit comprises at least one linear unit having a single linear portion along which there are three lighting elements.

4. The modular lighting system of claim 2, further comprising at least one L-shaped unit having a long linear portion and a short linear portion, wherein there are at least three lighting elements along the long linear portion and at least two lighting elements along the short linear portion and wherein a lighting element at a corner of the L-shaped unit is common to both the long linear portion and the short linear portion.

5. The modular lighting system of claim 2, further comprising at least one reverse L-shaped unit having a long linear portion and a short linear portion, wherein there are at least three lighting elements along the long linear portion and at least two lighting elements along the short linear portion and wherein a lighting element at a corner of the L-shaped unit is common to both the long linear portion and the short linear portion.

6. The modular lighting system of claim 1, wherein the center unit and each of the plurality of additional lighting units each have a power supply mounted thereon.

7. The modular lighting system of claim 1, wherein the center unit includes a camera disposed at a center of the center unit.

8. The modular lighting system of claim 1, wherein each lighting element includes a central lighting element that is surrounded by a plurality of color strip lighting elements.

9. The modular lighting system of claim 8, wherein the plurality of color strip lighting elements includes two red light color strips, one infrared light color strip, and one blue light color strip.

10. A modular lighting system for creating a scalable staggered matrix of lighting elements over a growing area, comprising:
a center unit having a rectangular or square configuration having four corners that define at least two regular rows and at least two regular columns, wherein the regular rows of the at least two regular rows are spaced one standard distant unit apart and the regular columns of the at least two regular columns are spaced one standard distant unit apart, wherein the at least two regular rows and at least to regular columns form a plurality of intersections, the center unit further having a plurality of lighting elements, each lighting element of the plurality of lighting elements is disposed at a respective intersection of the plurality of intersections, and there is at least one lighting element interspersed midway between the at least two regular rows and the at least two regular columns;
at least one linear unit having a single linear portion along which there are at least two lighting elements that are spaced apart by one standard distance unit along the single linear portion;
at least one at least one L-shaped unit, each having a long linear portion and a short linear portion, wherein there are at least three lighting elements along the long linear portion that are spaced apart at intervals of one standard distance unit, and at least two lighting elements along the short linear portion that are spaced apart at intervals of one standard distance unit, and wherein a lighting element at a corner of the L-shaped unit is common to both the long linear portion and the short linear portion; and
wherein the at least one linear unit, at least one L-shaped unit, and at least one reverse L-shaped unit are configured to be positioned around a staggered matrix comprising at least the center unit at positions that extend the staggered matrix outward from the center unit.

11. The modular lighting system of claim 10, wherein each of the center unit, at least one linear unit, at least one L-shaped unit each include a power supply.

12. The modular lighting system of claim 10, wherein each of the lighting elements on the center unit, at least one linear unit, and at least one L-shaped unit is a chip on board (COB) light emitting diode lighting element.

13. The modular lighting system of claim 10, wherein the at least one L-shaped unit is a reverse L-shaped unit.

14. The modular lighting system of claim 10, wherein the at least one L-shaped unit includes at least one reverse L-shaped unit.

15. The modular lighting system of claim 10, further comprising at least one reverse L-shaped unit having a long linear portion and a short linear portion, wherein there are at least three lighting elements along the long linear portion that are spaced apart at intervals of one standard distance unit, and at least two lighting elements along the short linear portion that are spaced apart at intervals of one standard distance unit, and wherein a lighting element at a corner of the L-shaped unit is common to both the long linear portion and the short linear portion.

16. A method of arranging lighting elements of a modular lighting system wherein the lighting elements are positioned in a staggered matrix, comprising:
providing a center unit having a rectangular or square configuration having four corners that define at least two regular rows and at least two regular columns, wherein the regular rows of the at least two regular rows are spaced one standard distant unit apart and the regular columns of the at least two regular columns are spaced one standard distant unit apart, wherein the at least two regular rows and at least to regular columns form a plurality of intersections, the center unit further having a plurality of lighting elements, each lighting element of the plurality of lighting elements is disposed at a respective intersection of the plurality of intersections, and there is at least one lighting element interspersed midway between the at least two regular rows and the at least two regular columns;
providing at least one linear unit having a single linear portion along which there are at least two lighting elements that are spaced apart by one standard distance unit along the single linear portion;
providing at least one at least one L-shaped unit, each having a long linear portion and a short linear portion, wherein there are at least three lighting elements along the long linear portion that are spaced apart at intervals of one standard distance unit, and at least two lighting elements along the short linear portion that are spaced apart at intervals of one standard distance unit, and wherein a lighting element at a corner of the L-shaped unit is common to both the long linear portion and the short linear portion;
arranging a central staggered matrix including at least the center unit; and
positioning at least two of the at least one linear unit or the at least one L-shaped unit around the staggered matrix at positions that extend the staggered matrix outward from the center unit.

17. The method of claim 16, wherein providing at least one at least one L-shaped unit comprises providing at least one reverse L-shaped unit.

18. The method of claim 16, wherein at least one at least one L-shaped unit comprises providing at least one regular L-shaped unit and at least one reverse L-shaped unit.

19. The method of claim 16, wherein providing the center unit comprises providing the center unit with a camera disposed at a center of the center unit.

20. The method of claim 19, further comprising:
providing each lighting element of the plurality of lighting elements with two red light color strips, one infrared light color strip, and one blue light color strip around a central lighting element;
receiving, via the camera, image data of a plant canopy under the modular lighting system; and
adjusting, individually, responsive to the image data, a light output level of each lighting element of the plurality of lighting elements, including individually adjusting and output of each of the two red light color strips, the one infrared light color strip, the one blue light color strip, and the central light element of each lighting element of the plurality of lighting elements.
